(19) United States
(12) Patent Application Publication
(10) Pub. No.: US 2015/0172794 A1
(43) Pub. Date: Jun. 18, 2015

(54) SWITCH DEVICE

(71) Applicant: Furukawa Electric Co., Ltd., Tokyo (JP)

(72) Inventors: Junichi HASEGAWA, Tokyo (JP); Noritaka MATSUBARA, Tokyo (JP); Kazutaka NARA, Tokyo (JP)

(73) Assignee: Furukawa Electric Co., Ltd., Tokyo (JP)

(21) Appl. No.: 14/613,955

(22) Filed: Feb. 4, 2015

Related U.S. Application Data
(63) Continuation of application No. PCT/JP2013/004920, filed on Aug. 20, 2013.

(30) Foreign Application Priority Data
Sep. 27, 2012 (JP) 2012-214621

(51) Int. Cl. H04Q 11/00; H04J 14/02

(52) U.S. Cl. CPC H04Q 11/0005; H04J 14/0215; H04Q 2011/0015

(57) ABSTRACT

An object of the invention is to provide a switch device, which achieves high expandability, high layout freedom, and low losses. A switch device of an embodiment includes a splitter unit, a first switch unit, a second switch unit, a fiber array which connects the splitter unit to the two switch units, and a control board. The fiber array includes multiple optical fibers bundled in an arrayed fashion. At an end of the fiber array on the splitter unit side, all the optical fibers are bundled into one and connected to the splitter unit. At an end of the fiber array on the switch unit side, the multiple optical fibers are divided into two groups and formed into two sub-fiber arrays, which are connected to the first switch unit and the second switch unit, respectively.

### CROSS-REFERENCES TO RELATED APPLICATIONS

This application is a continuation application of International Application No. PCT/JP2013/004920, filed Aug. 20, 2013, which claims the benefit of Japanese Patent Application No. 2012-214621, filed Sep. 27, 2012. The contents of the aforementioned applications are incorporated herein by reference in their entireties.

### TECHNICAL FIELD

The present invention relates to a switch device for optical signals, or to a switch device used to add and drop an optical signal in wavelength division multiplexing, in particular.

### BACKGROUND ART

The ROADM (reconfigurable optical add/drop multiplexer) technology has been contrived in recent years in order to increase the speed and capacity in optical communications. An ROADM optical network uses wavelength division multiplexing, and enables an optical signal at an arbitrary wavelength to be added or dropped without being converted into an electric signal. Moreover, in the ROADM optical network, when paths where to pass optical signals at various wavelengths need to be changed (or a pass needs to be newly set up or discontinued), the paths can be changed, i.e., are reconfigurable without the need of any construction work for connection.

In order to realize the ROADM, a switch device is needed which can handle input and output of multiple wavelengths and change paths therefor (such a switch device is also referred to as a multicast switch). More specifically, the switch device used in the ROADM has: a function to receive an input of an optical signal from a client device and to add the optical signal to a route in a ROADM network; and a function to output an optical signal, which is dropped from a route in the ROADM network, to a client device, and is capable of dynamically changing the paths that the optical signals pass through.

For example, Non Patent Document 1 discloses an example of a switch device used in the ROADM. The switch device of Non Patent Document 1 is fabricated by using a planar lightwave circuit (PLC). Here, the switch device includes 1×2 splitters, 2×1 switches, and gate switches, all of which are provided on one chip.

### CITATION LIST

### Non Patent Document

Non Patent Document 1: T. Watanabe et al., “Compact PLC Transponder Aggregator for Colorless, Directionless, and Contentionless ROADM”, The Optical Fiber Communication Conference and Exposition and the National Fiber Optic Engineers Conference, OTuD3, 2011.

### SUMMARY OF INVENTION

In the switch device described in Non Patent Document 1, the design of the chip itself needs to be modified when the number of inputtable and outputtable wavelengths (a wavelength quantity) is changed. In other words, this switch device can hardly achieve sufficient expandability. Moreover, using the PLC, the switch device cannot achieve three-dimensional wiring unlike the case of using optical fibers, and therefore is low in the freedom of layout. For this reason, when larger numbers of the splitters and the switches are provided in order to increase the wavelength quantity, the chip is inevitably enlarged in its longitudinal direction. This makes it difficult to downsize this switch device. In addition, since all the splitters and the switches are connected by way of the PLC, the switch device includes numerous cross waveguides that eventually lead to losses due to the crossing.

An object of the present invention is to provide a switch device, which achieves high expandability, high layout freedom, and low losses.

An aspect of the present invention provides a switch device configured to add and drop an optical signal to and from an optical network, which includes: an optical splitter configured to split and combine the optical signal; a first chip including at least one optical switch configured to select a path for the optical signal; a second chip including at least one optical switch configured to select a path for the optical signal; and a fiber array including multiple optical fibers configured to connect the optical splitter to the optical switch of the first chip and the optical switch of the second chip.

The switch device of the present invention achieves high expandability, high layout freedom, and low losses.

### BRIEF DESCRIPTION OF DRAWINGS

FIG. 1 is a schematic configuration diagram of a switch device according to a first embodiment.

FIG. 2 is a schematic diagram showing a wiring system of the switch device.

FIG. 3 is a schematic diagram showing configurations of an optical switch and a tap coupler.

FIG. 4 is a graph showing a relation between the loss and the number of arrays of optical switches on one chip.

FIG. 5 is a schematic configuration diagram of a switch device according to a second embodiment.

FIG. 6 is a schematic configuration diagram of a switch device according to a third embodiment.

FIG. 7 is a schematic configuration diagram of a switch device according to a fourth embodiment.

### DESCRIPTION OF EMBODIMENTS

Embodiments of the present invention will be described below with reference to the drawings. It is to be noted, however, that the present invention is not limited only to these embodiments. In the drawings used in the following descriptions, those having the same functions will be denoted by the same reference numerals and overlapping descriptions thereof may be omitted as appropriate.

### First Embodiment

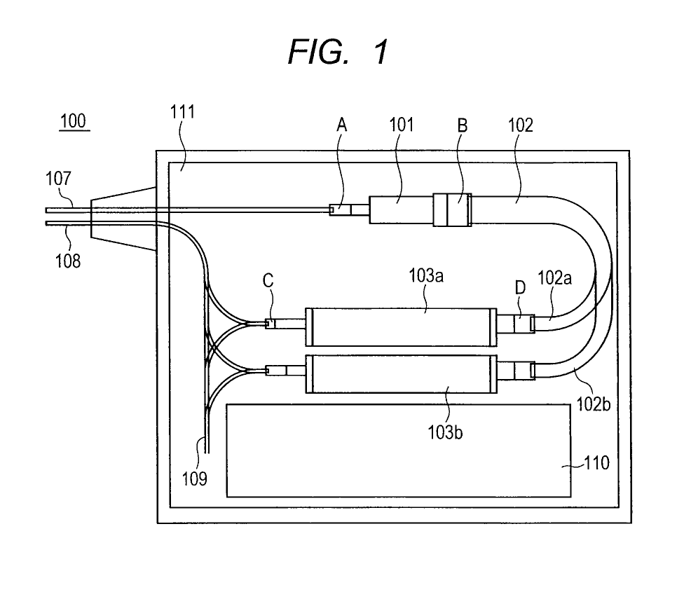

FIG. 1 is a schematic configuration diagram of a switch device 100 of this embodiment. The switch device 100 can be connected between multiple client devices and a ROADM network having multiple routes. Thus, the switch device 100 is capable of dropping an optical signal from a route in the ROADM network, and passing the optical signal to a desired client device, or adding a signal from a client device to a desired route in the ROADM network.

The switch device 100 includes a splitter unit 101, a first switch unit 103a, a second switch unit 103b, a fiber array 102 configured to connect the splitter unit 101 to the two switch units 103a and 103b, and a control board 110 serving as a power supply channel to the two switch units 103a and 103b. The splitter unit 101, the switch units 103a and 103b, the fiber array 102, and the control board 110 are housed in an enclosure 111.

The splitter unit 101 as well as the two switch units 103a and 103b each have a substantially rectangular parallelepiped shape, and are disposed in the enclosure 111 in this order and in a way that side faces in the longitudinal direction of the rectangular parallelepipeds are arranged parallel to one another. Here, it is easier to reduce the switch device 100 in size by disposing the splitter unit 101 and the two switch units 103a and 103b in a way that the side faces are arranged parallel to one another as described above. Nevertheless, they do not always have to be disposed parallel to one another. In the meantime, the cross-sectional shape of each of the splitter unit 101 and the two switch units 103a and 103b is not limited to a rectangle. A branch terminal B of the splitter unit 101 and branch terminals D of the switch units 103a and 103b are located on the same side. Moreover, the branch terminal B of the splitter unit 101 is connected to the branch terminals D of the switch units 103a and 103b by using the fiber array 102 which is bent in a U-shape.

A common terminal A of the splitter unit 101 is connected to the ROADM network through a network side fiber 107. Common terminals C of the two switch units 103a and 103b are respectively connected to client devices through a client side fiber 108, and are also connected through a PD (photodiode) side fiber 109 to a not-illustrated PD for checking operating states.

FIG. 2 is a schematic diagram showing a wiring system of the switch device 100. FIG. 2 illustrates only part of wiring in the fiber array 102 for the sake of simplification.

The splitter unit 101 includes eight optical splitters 104 on one chip. Each optical splitter 104 used in this embodiment is a 1×8 optical splitter provided with one common port E on one end and eight branch ports F on another end. An optical signal inputted from the common port E is split and outputted from the eight branch ports F. Alternatively, optical signals inputted from the eight branch ports E are combined together and outputted from the common port E. The splitter unit 101 is fabricated by using a PLC formed on a quartz substrate, and its relative refractive index difference Δ between a core and a clad is about 0.4%, for example. By adopting the low relative refractive index difference Δ, a connection loss can be reduced.

The switch unit 103a includes four optical switches 105, and tap couplers 106 connected respectively to the optical switches 105, all of which are provided on one chip. Meanwhile, the switch unit 103b has the same configuration as the switch unit 103a. Each of the switch units 103a and 103b is fabricated by using a PLC formed on a silicon substrate, and its relative refractive index difference Δ between a core and a clad is about 1.5%, for example. By setting the high relative refractive index difference Δ, a connection loss tends to increase but reduction in size is achieved instead. Each of the switch units 103a and 103b includes many Mach-Zehnder interferometers (MZIs). Accordingly, an external size of each of the switch units 103a and 103b tends to increase. For this reason, the switch units 103a and 103b adopt the high relative refractive index difference Δ, thereby achieving the reduction in size.

As described above, in this embodiment, the splitter unit 101 and the switch units 103a and 103b are each provided on a different substrate. Thus, it is possible to design the respective chips separately such that each chip has suitable properties including the relative refractive index difference.

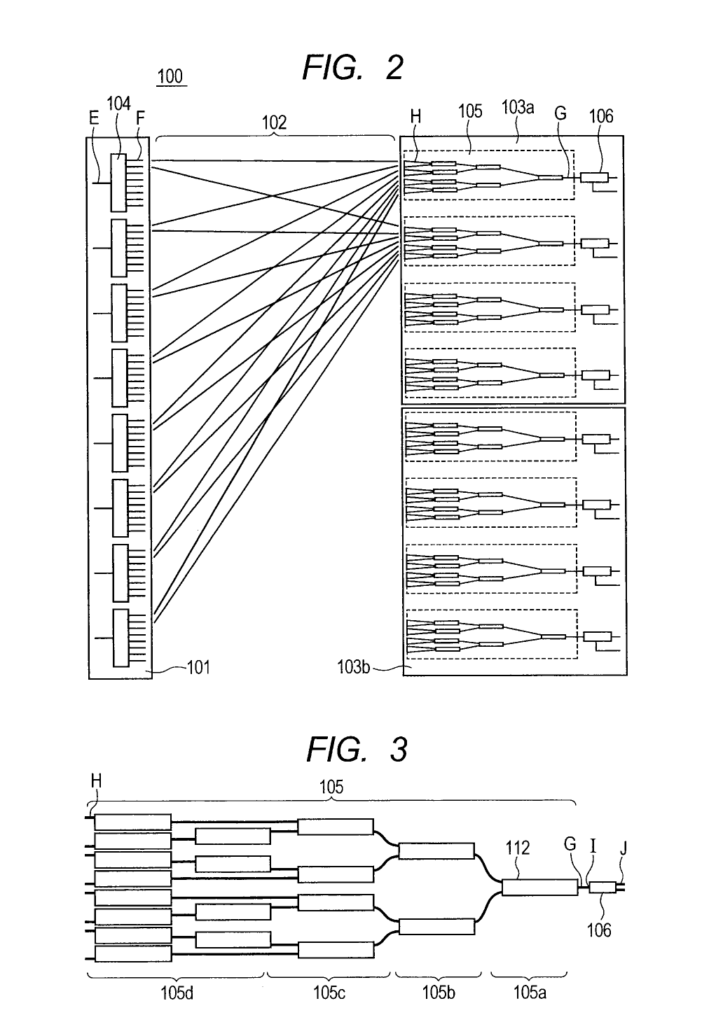

FIG. 3 is a schematic diagram showing configurations of each optical switch 105 and the tap coupler 106. The optical switch 105 is provided with eight branch ports H on one end and one common port G on another end. The optical switch 105 includes multiple Mach-Zehnder interferometers (MZIs) 112 connected in a cascade fashion. Each MZI 112 includes two input ports on one end and two output ports on another end. Note that the MZI 112 is directionless and the terms of the input ports and the output ports used herein are intended solely for distinction. Accordingly, any ports of the MZI 112 can be used for both the input and output purposes.

Two couplers (which are directional couplers in this embodiment) and two waveguides sandwiched by the two couplers are provided between the input ports and the output ports of each MZI 112. Moreover, a heater (not shown) is provided in the vicinity of at least one of the two waveguides. In an unheated state, an optical signal inputted from one of the two input ports is adjusted to be outputted from one of the two output ports. Here, when one of the two waveguides is heated, a propagation velocity of light in that waveguide is reduced so as to change the behavior of the optical signal in such a way as to be outputted from the other of the two output ports. Accordingly, the output of the signal inputted from the input port can be selected from the two output ports by controlling on and off of the heating with the heater. The heater is connected to the control board 110 by using an arbitrary connecting method, and the heating with the heater can be switched by controlling power supply from the control board 110 to the heater. This configuration enables the optical switch 105 to dynamically change a path for allowing passage of the optical signal therein.

As for the couplers, the MZIs 112 may use not only the DCs (directional couplers) but also WINCs (wavelength insensitive couplers), Y branches, and the like based on their characteristics.

As described above, the optical switch 105 includes the multiple MZIs 112 which are connected in a cascade fashion. One MZI 112 is provided on a first tier 105a of the optical switch 105. The tap coupler 106 is connected to one of two input ports of this MZI 112, and two input ports of two MZIs on a second tier 105b are respectively connected to two output ports of this MZI 112. Output ports of the two MZIs (four ports in total) on the second tier 105b are respectively connected to input ports of four MZIs on a third tier 105c. Output ports of the four MZIs (eight ports in total) on the third tier 105c are connected to a gate switch unit 105d. In the gate switch unit 105d, one MZI is connected to one of two output ports of each MZI on the third tier 105c while two MZIs are connected in series to the other one of the two output ports thereof. The gate switch unit 105d can improve extinction ratios even when the power is off.

The tap coupler 106 is provided with one common port I on one end and two branch ports J on another end. The common port I of the tap coupler 106 is connected to the common port G of the optical switch 105, and one of the two branch ports J is connected to the client side fiber 108 while the other one of the two branch ports J is connected to the PD (not shown) through the PD side fiber 109. Optical output from the optical switch 105 can be monitored by using the PD. Although a branching ratio of the tap coupler 106 can be set arbitrarily, 5% is branched to the PD side in this embodiment.

In each of the switch units 103a and 103b of this embodiment, four pieces (four arrays) of 8×1 switches 105 are disposed on one chip. The configuration to provide a predetermined number of the optical switches on one chip and to provide the multiple chips of this structure facilitates expansion in the case of increasing the wavelength quantity, and enables control of manufacturing costs, connection losses, and the like. Here, the following advantages are obtained particularly by applying the four-arrays-per-chip configuration to each switch unit.

First, it is possible to reduce connection losses. In general, the number of cores in an optical fiber array to be connected to the 8×1 optical switches is increased more as the number of arrays of the optical switches on one chip becomes larger. This leads to an increase in pitch misalignment (an error in pitch between cores) to be caused in the course of manufacturing the fiber array. A connection loss becomes larger if the fiber array involving the misaligned fixation positions as described above is connected to optical switches. In particular, the optical switches are more susceptible to axial misalignment when the substrate with the high relative refractive index difference (Δ=1.5%) is used, as described in this embodiment, for the purpose of reducing the optical switches in size. Accordingly, it is preferable that the number of arrays of optical switches on one chip be not set too large.

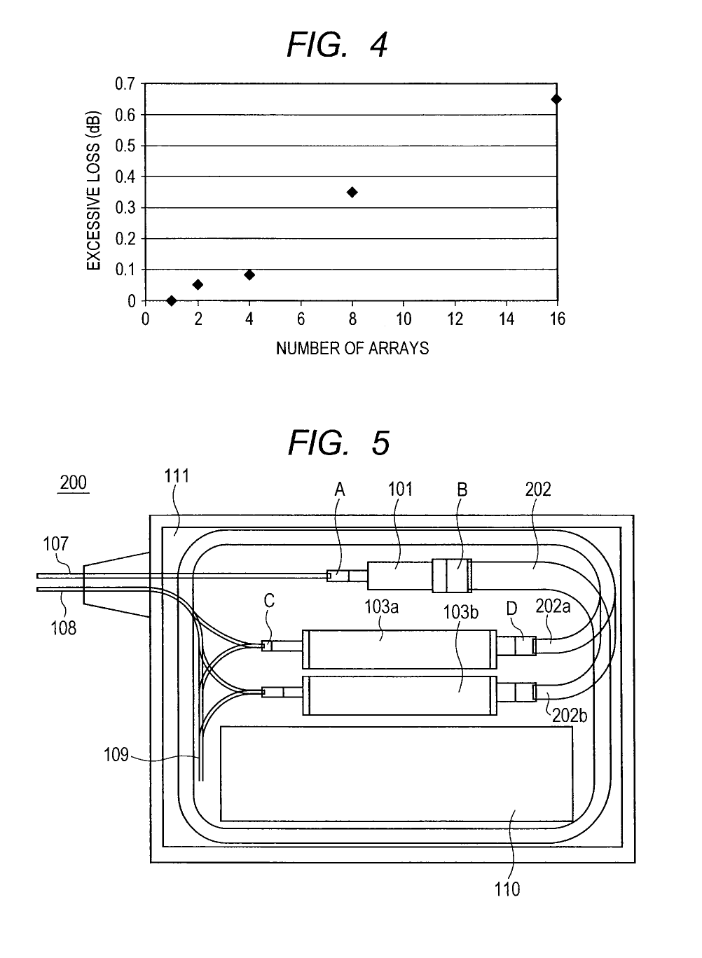

A connection loss when the fiber array is connected to the optical switches can be calculated on the basis of the worst value of the pitch misalignment (that is, an upper limit of values of specifications of the pitch misalignment). FIG. 4 is a graph showing a relation between the number of arrays of the optical switches and an excessive loss calculated from the pitch misalignment (a ratio of the connection loss on the assumption that the connection loss is 0 dB when the number of arrays is equal to 1). The horizontal axis in FIG. 4 indicates the number of arrays of the optical switches on one chip while the vertical axis therein indicates the excessive loss.

It is clear from FIG. 4 that the excessive loss (the connection loss) sharply increases when the optical switches to be disposed on one chip exceed four arrays. For this reason, it is preferable that four arrays of the optical switches or less be disposed on one chip.

Second, it is possible to reduce costs. An increase in the number of the optical switches to be disposed on one chip leads to an increase in the area of the chip. As a consequence, use efficiency of each wafer is reduced (in other words, the area of a portion of each wafer unused for the chips and hence wasted becomes larger). In the meantime, if just one defect such as a waveguide defect occurs on one chip, the entire chips are regarded as a defective product and production yield is therefore reduced. For this reason, manufacturing costs are increased when the number of the optical switches is set too large.

On the other hand, if the number of the optical switches to be disposed on one chip is reduced, the number of the fiber arrays to be connected is increased. Hence, the number of times of core alignment work is increased and more time is required as a consequence. For example, this embodiment provides two switch units each including four arrays and the work to connect the fiber arrays and the switch units has to be conducted twice. Meanwhile, in the case of providing four switch units each including two arrays, such connection work is increased to four times. For this reason, the manufacturing costs are also increased when the number of the optical switches is set too small.

Due to the reasons mentioned above, it is preferable to provide four arrays of the 8×1 optical switches on one chip in order to keep both the connection losses and the costs in good conditions.

Nevertheless, the number of the optical switches to be disposed on one chip is not limited only to four. The number of arrays on one chip may be determined as appropriate based on experiments or calculations.

The fiber array 102 includes multiple optical fibers bundled in an arrayed fashion. In this embodiment, sixty-four optical fibers are used. At an end of the fiber array 102 on the splitter unit 101 side, the sixty-four optical fibers are bundled into one and connected to the splitter unit 101. At an end of the fiber array 102 on the switch units 103a and 103b side, the optical fibers are divided into 32 optical fibers each and formed into two sub-fiber arrays 102a and 102b. The sub-fiber array 102a is connected to the first switch unit 103a and the sub-fiber array 102b is connected to the second switch unit 103b.

The fiber array 102 is partially bundled into an array and partially separated into single optical fibers. In this way, the layout freedom of the fiber array is increased so that the fiber array can be bent with a small curvature or three-dimensionally arranged. The use of this fiber array enables reduction in size of the enclosure.

The numbers of the optical fibers included in the fiber array 102 and the sub-fiber arrays 102a and 102b are not limited to the numbers cited in this embodiment, but are to be determined on the basis of the numbers of the optical splitters and the optical switches as well as the numbers of the branch ports therein. Generally speaking, the sub-fiber array 102a is formed from part of the multiple optical fibers included in the fiber array 102 and is connected to the switch unit 103a, while the sub-fiber array 102b is formed from the rest of the multiple optical fibers and is connected to the other switch unit 103b. The number of the sub-fiber arrays may be three or more, being equal to the number of the chips of the switch units.

The fiber array 102 is arranged in a U-shape. One end of the U-shape is connected to the branch terminal B of the splitter unit 101, and the other end thereof is divided into the two sub-fiber arrays 102a and 102b, which are connected to the branch terminals D of the first switch unit 103a and the second switch unit 103b, respectively. The switch device 100 can be formed smaller by reducing the curvature of the U-shape. However, the reduction in curvature of the U-shape is constrained by a minimum allowable bending radius R of each of the optical fibers included in the fiber array 102. For this reason, in order to achieve the reduction in size, it is preferable to use optical fibers which are less likely to increase transmission losses even when the optical fibers are bent with small curvatures, or more specifically, to use optical fibers with R=5 mm, for example.

As schematically shown in FIG. 2, the branch ports F of each optical splitter 104 are respectively connected to the branch ports H of the different optical switches 105 through the optical fibers of the fiber array 102. For this reason, four ports out of the eight branch ports F of each optical splitter 104 are connected to the first switch unit 103a through the sub-fiber array 102a while the remaining four ports are connected to the second switch unit 103b through the sub-fiber array 102b.

When the optical splitters 104 and the optical switches 105 are connected as described above, optical transmission paths inevitably cross one another. When this connection is established by way of the PLC, the waveguides need to be crossed on a plane, and crossing losses occur as a consequence. On the other hand, according to this embodiment, no crossing losses occur since the connection is established three-dimensionally by using the optical fibers. In addition, it is possible to reduce losses since the optical fibers do not have to be fusion-spliced to one another. Furthermore, the use of the optical fibers for establishing the connection achieves high layout freedom by enabling the arrangement of the optical fibers in the U-shape (a boomerang shape) and the like as shown in this embodiment as an example, thereby enabling the reduction in size.

For instance, the dimensions of the enclosure of the switch device of this embodiment can be reduced to about 150×150×14 mm.

The splitter unit 101, the switch units 103a and 103b, and the control board 110 are fixed to the enclosure 111 by using an adhesive and the like. In order to efficiently diffuse the heat generated by the heaters of the optical switches, the enclosure 111 is made of a highly heat-conductive material such as aluminum. Moreover, it is preferable to provide the enclosure 111 with heat radiation fins in order to improve its heat radiation performance.

An operation to drop an optical signal from the ROADM network to pass the optical signal to a client device by using the switch device 100 will be described below.

First, an optical signal having a specific wavelength X is inputted from the ROADM network to the common port E of a certain one of the optical splitters 104 included in the splitter unit 101. The optical signal is split by the certain optical splitter 104 and outputted respectively from the branch ports F. The split optical signals respectively pass through the fiber array 102 and are inputted to the branch ports H of the optical switches 105 included in the switch units 103a and 103b.

In each of the optical switches 105, when the wavelength λ of the inputted optical signal is a desired wavelength to be outputted from the optical switch 105, the path in the optical switch 105 is controlled by the control board 110 such that the optical signal is outputted from the common port G of the optical switch 105 to the client device. On the other hand, when the wavelength λ of the inputted signal is not the desired wavelength to be outputted from the optical switch 105, the path in the optical switch 105 is controlled by the control board 110 such that the optical signal is not outputted from the common port G of the optical switch 105.

By performing this operation, it is possible to select the path for passing the optical signal from the ROADM network such that the optical signal is dropped and passed to the desired client device through the optical splitter and the optical switch.

An operation to add an optical signal from the client device to the ROADM network by using the switch device 100 will be described below.

First, an optical signal having the specific wavelength λ is inputted from the client device to the common port G of a certain one of the optical switches 105 included in the switch units 103a and 103b. In the certain optical switch 105, the path in the optical switch 105 is controlled by the control board 110 such that the optical signal is outputted from the branch port H connected to a desired optical splitter 104 corresponding to the wavelength λ of the optical signal (i.e., a desired route in the ROADM network). The optical signal passes through the fiber array 102 and is inputted to the branch port F of the optical splitter 104. Thereafter, the optical signal is outputted to the route in the ROADM network connected to the optical splitter 104.

By performing this operation, it is possible to select the path for passing the optical signal from the client device such that the optical signal is added to the desired route in the ROADM network through the optical switch and the optical splitter.

The number of the optical splitters 104, the number of the branch ports of each optical splitter 104, the number of the optical switches 105, and the number of the branch ports of each optical switch 105 are not limited to the numbers cited in this embodiment. These numbers can be set arbitrarily depending on a route quantity (defined as N) in the ROADM network and on the wavelength quantity (defined as M).

The number of the branch ports of each optical splitter 104 corresponds to the wavelength quantity M used in the switch device 100 and can be set arbitrarily depending on the wavelength quantity M. When the wavelength quantity is M, a 1×M optical splitter having one common port and M branch ports may be used. The branch ports of one optical splitter 104 are connected to the different optical switches 105.

The number of the optical splitters 104 corresponds to the route quantity N in the ROADM network and can be set arbitrarily depending on the route quantity N. Specifically, if the route quantity is N, then N pieces of the optical splitters are provided and are respectively connected to the routes.

The number of the branch ports of each optical switch 105 corresponds to the route quantity N in the ROADM network (i.e., the number of the optical splitters 104) and can be set arbitrarily depending on the route quantity N. When the route quantity is N, an N×1 optical switch having N branch ports and one common port may be used. The branch ports of one optical switch 105 are connected to the branch ports of the different optical splitters 104.

The number of the optical switches 105 corresponds to the wavelength quantity M used in the switch device 100 (i.e., the number of the branch ports of each optical splitter 104) and can be set arbitrarily depending on the wavelength quantity M. Specifically, if the wavelength quantity is M, then M pieces of the optical switches are provided.

### Second Embodiment

FIG. 5 is a schematic configuration diagram of a switch device 200 of this embodiment. Here, only the layout of the fiber array is different from that in the first embodiment and the rest of the configurations are the same as the first embodiment.

A fiber array 202 of the switch device 200 is disposed in such a way as to go around along inner walls of the enclosure 111 and to surround the splitter unit 101, the switch units 103a and 103b, and the control board 110. One end of the fiber array 202 is connected to the splitter unit 101. After the fiber array 202 goes around along the inner walls of the enclosure 111, another end of the fiber array 202 is divided into two sub-fiber arrays 202a and 202b and are connected to the first switch unit 103a and the second switch unit 103b, respectively.

By arranging the fiber array in such a way as to go around inside the enclosure 111 as described in this embodiment, the bending of the fiber array is relaxed as compared to the case of the U-shaped layout. For this reason, it is possible to bring the splitter unit closer to the switch units even if the optical fibers having the minimum allowable bending radius equal to that in the case of the U-shaped layout are used. This makes it possible to achieve further reduction in size.

### Third Embodiment

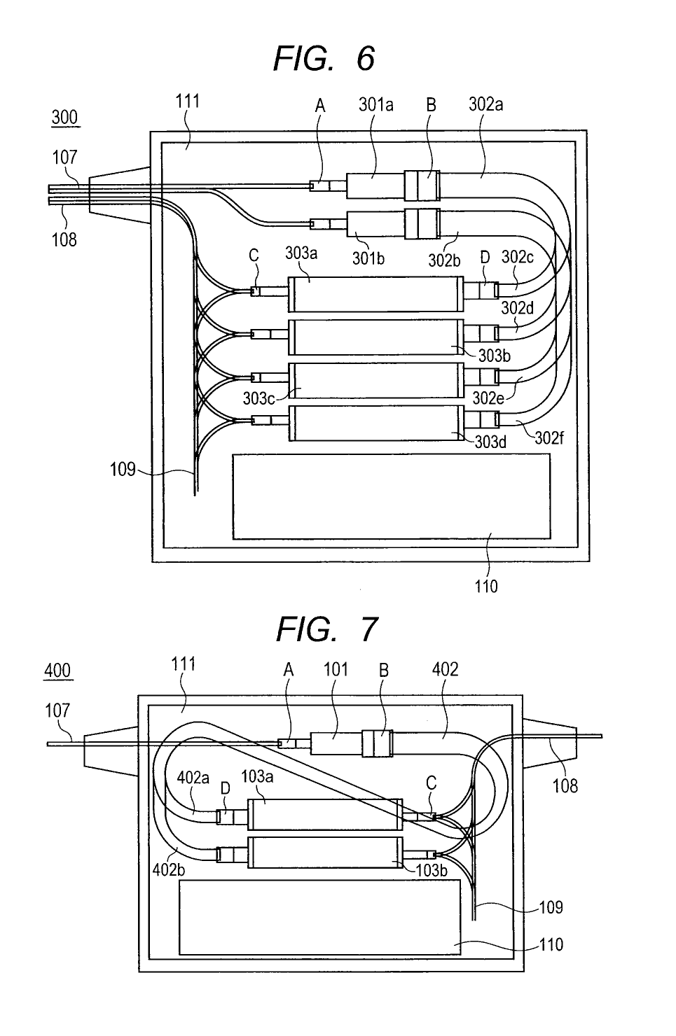

FIG. 6 is a schematic configuration diagram of a switch device 300 of this embodiment. This embodiment is different from the first embodiment only in that two sets of the splitter unit, the fiber array, and the switch units are provided. The rest of the configurations are the same as the first embodiment.

The switch device 300 includes two splitter units 301a and 301b, four switch units 303a, 303b, 303c, and 303d, and two fiber arrays 302a and 302b. The two splitter units 301a and 301b as well as the four switch units 303a, 303b, 303c, and 303d each have a columnar shape, and are disposed in the enclosure 111 in this order and in a way that side faces of the columns are arranged parallel to one another.

Each of the fiber arrays 302a and 302b is arranged in a U-shape as in the first embodiment. Specifically, the branch terminal B of the splitter unit 301a and the branch terminals D of the switch units 303a and 303b are located on the same side. The branch terminal B of the splitter unit 301a is connected to the branch terminals D of the switch units 303a and 303b by using the U-shaped fiber array 302a. In the meantime, the branch terminal B of the splitter unit 301b and the branch terminals D of the switch units 303c and 303d are located on the same side. The branch terminal B of the splitter unit 301b is connected to the branch terminals D of the switch units 303c and 303d by using the U-shaped fiber array 302b.

One end of the U-shape of the fiber array 302a is connected to the branch terminal B of the splitter unit 301a, and the other end thereof is divided into two sub-fiber arrays 302c and 302d, which are connected to the branch terminals D of the switch units 303a and 303b, respectively. In the meantime, one end of the U-shape of the fiber array 302b is connected to the branch terminal B of the splitter unit 301b, and the other end thereof is divided into two sub-fiber arrays 302e and 302f, which are connected to the branch terminals D of the switch units 303c and 303d, respectively.

By providing the two sets of the splitter unit, the fiber array, and the switch units as described in this embodiment, it is possible to utilize a space between the splitter unit 101 and the switch units 103a and 103b in the first embodiment. As a consequence, the space can be efficiently utilized so that the reduction in size can be achieved in the case of increasing the numbers of input and output systems.

Moreover, in this embodiment, it is also possible to achieve further reduction in size by causing the fiber arrays to go around inside the enclosure as in the second embodiment.

### Fourth Embodiment

FIG. 7 is a schematic configuration diagram of a switch device 400 of this embodiment. Here, only the layouts of the splitter unit 101, the switch units 103a and 103b, and a fiber array are different from those in the first embodiment and the rest of the configurations are the same as the first embodiment.

Unlike the first embodiment, the branch terminal B of the splitter unit 101 is disposed on the opposite side from the branch terminals D of the switch units 103a and 103b in this embodiment. The branch terminal B of the splitter unit 101 is connected to the branch terminals D of the switch units 103a and 103b by using an S-shaped fiber array 402. Specifically, one end of the S-shape of the fiber array 402 is connected to the branch terminal B of the splitter unit 101, and the other end thereof is divided into two sub-fiber arrays 402a and 402b, which are connected to the branch terminals D of the first switch unit 103a and the second switch unit 103b, respectively.

By arranging the fiber array in the S-shape as described in this embodiment, the bending of the fiber array is relaxed as compared to the case of the U-shaped layout. For this reason, it is possible to bring the splitter unit closer to the switch units by using the optical fibers having the minimum allowable bending radius equal to that in the case of the U-shaped layout. This makes it possible to achieve further reduction in size.

The present invention is not limited only to the above-described embodiments and various modifications are possible as appropriate without departing from the scope of the invention.

1. A switch device configured to add and drop an optical signal to and from an optical network, comprising:
an optical splitter configured to split and combine the optical signal;
a first chip including at least one optical switch configured to select a path for the optical signal;
a second chip including at least one optical switch configured to select a path for the optical signal; and
a fiber array including a plurality of optical fibers connecting the optical splitter to the optical switch of the first chip and the optical switch of the second chip.

2. The switch device according to claim 1, wherein
part of the plurality of the optical fibers of the fiber array are connected to the optical switch of the first chip, and
other part of the plurality of the optical fibers of the fiber array different from the part are connected to the optical switch of the second chip.

3. The switch device according to claim 2, wherein the optical fibers connected to the optical switch of the first chip three-dimensionally cross the optical fibers connected to the optical switch of the second chip.

4. The switch device according to claim 1, wherein
the first chip includes four pieces of the optical switches,
the second chip includes four pieces of the optical switches,
the optical switches of the first chip and the optical switches of the second chip are each an 8×1 optical switch.

5. The switch device according to claim 1, further comprising:
a third chip including the optical splitter, wherein
the first chip, the second chip, and the third chip are each formed by using a planar lightwave circuit (PLC).

6. The switch device according to claim 5, wherein the first chip, the second chip, and the third chip are respectively formed by using the planar lightwave circuits (PLCs) which are different in relative refractive index difference.
